(19) United States
(12) Patent Application Publication
(10) Pub. No.: US 2016/0335597 A1
(43) Pub. Date: Nov. 17, 2016

(54) SERVER FOR PROVIDING INFORMATION FOR GROUP DECISION AND METHOD THEREOF

(71) Applicant: Perception, Seoul (KR)

(72) Inventor: Kisuk OH, Seoul (KR)

(21) Appl. No.: 14/711,908

(22) Filed: May 14, 2015

(30) Foreign Application Priority Data
May 12, 2015 (KR) 10-2015-0065853

(51) Int. Cl. G06Q 10/10; H04L 29/06; G06F 17/30

(52) U.S. Cl. CPC G06Q 10/101; G06F 17/3053; G06Q 10/105; H04L 65/403

(57) ABSTRACT

A group decision support server includes a project creation unit configured to register a first group of drafts including at least one or more draft and create a project for evaluating the drafts; a first evaluation configured to yield a first evaluation result based on evaluation information of a first preference base inputted from the participant when the participant participates in the project; a second evaluation unit configured to select a final draft that has the most favorable evaluation based on the first evaluation result and an evaluation information of a second weighted value base inputted from the participant.

### CROSS-REFERENCE TO RELATED APPLICATION

This application claims priority to Korean Patent Application No. 10-2015-0065853, filed on May 12, 2015, the disclosure of which is incorporated herein in its entirety by reference.

### FIELD OF THE INVENTION

The present invention relates to an online survey, and more particular, in group decision support to select a draft in accord with a request of a client among at least one or more drafts provided from an expert group such as a designer in accordance with a request of product design, advertisement design, service design, and package design etc., to a group decision support server and method for providing help to group decision when the draft is selected without formulaic determination criteria such as a design by selecting a certain number of drafts through a first evaluation based on evaluation information by participants of a client regarding the drafts provided by the expert group, and by recommending a draft in accord with a request of the client through a second evaluation that a weighted value by participants and a weighted value by the evaluation criteria are again applied regarding the selected draft.

### BACKGROUND OF THE INVENTION

In these days, when a design company is requested a design draft on a specific product or advertisement, and service from a client such as an individual or a company, the design company provides the client with a number of design drafts expected in accord with a request of the client such that the design drafts may be directly selected by the client.

However, it may be very difficult work for a client who is inexpert to properly select a design draft in accord with product or service or advertisement, since there are no formulaic determination criteria with regard to the design draft.

To overcome difficulties in connection with selection of a design draft, a survey through an online or offline using a number of unspecified persons may be considered as a method for selecting the design draft having the highest preference. It is, however, not sufficient to determine that the selection is in accord with a request of a client or not based on the results of this simple survey method, and therefore, the reliability of the survey is uncertain.

Accordingly, in case of selecting a specific draft with respect to a draft such as a design, etc. without formulaic determination criteria, a method for more reliably evaluating a design draft is required to provide help to group decision by recommending the design draft in accord with a request of a client.

### SUMMARY OF THE INVENTION

In view of the above, the present invention provides an online survey, and more particular, in group decision support to select a draft in accord with a request of a client among at least one or more drafts provided from an expert group such as a designer in accordance with a request of product design, advertisement design, service design, and package design etc., to a group decision support server and method for providing help to group decision when the draft is selected without formulaic determination criteria such as a design by selecting a certain number of drafts through a first evaluation based on an evaluation information by participants of a client regarding the drafts provided by the expert group, and by recommending a draft in accord with a request of the client through a second evaluation that a weighted value by participants and a weighted value by the evaluation criteria are again applied regarding the selected draft.

In accordance with an embodiment of the present invention, there is provided a group decision support server, the server including: a project creation unit configured to register a first group of drafts including at least one or more draft and create a project for evaluating the drafts; a participant selection unit configured to select a participant who is to be participated in the project; an evaluation criteria setting unit configured to set at least one or more evaluation criteria on the draft; a first evaluation configured to yield a first evaluation result based on evaluation information of a first preference base inputted from the participant when the participant participates in the project; a second evaluation unit configured to select a final draft that has the most favorable evaluation based on the first evaluation result and an evaluation information of a second weighted value base inputted from the participant; and a control unit configured to execute the project and provide a final draft yielded in the second evaluation unit as final result information of the project.

Further, the first evaluation unit may be configured to provide a first evaluation screen including a name of the project when a user terminal of the participant is connected via a communications network; receive an evaluation information by the evaluation criteria and a general evaluation information on each of the drafts included in the first group of drafts; and yield a draft that has the highest preference by the evaluation criteria and the highest general evaluation as the first evaluation result.

Further, the first evaluation unit may be configured to select one draft that has the highest preference by an individual or a group of the participants in the manner of tournaments method on the drafts included in the first group of drafts; and yield the draft as the first evaluation result.

Further, the second evaluation unit may be configured to set at least one or more drafts selected among the drafts included in the first group of drafts as the second group of drafts based on the first evaluation result; display a second evaluation screen that the participant and the weighted value by the evaluation criteria are applied; receive an evaluation information by the evaluation criteria and the general evaluation information on each of the drafts included in the second group of drafts; yield a second evaluation result based on the inputted information and the weighted value; and select a final draft that has the most favorable evaluation among the drafts included in the second group of drafts based on the second evaluation result.

Further, the second evaluation unit may be configured to yield one draft that has the favorable evaluation based on the general evaluation information inputted from each of the participants and a weighted value of each of the participant; yield at least one or more drafts that have the favorable evaluation by the evaluation criteria based on the evaluation information by the evaluation criteria inputted from the participant and the weighted value by the evaluation criteria and the weighted value of the participant; and yield them as the second evaluation result.

Further, the first evaluation unit may be configured to receive a draft that has the lowest preference among the first group of drafts; and eliminate the draft from the first group of drafts.

Further, the second evaluation unit may be configured to add at least one draft selected by the participant among the eliminated drafts in the first evaluation or at least one draft selected by an expert group to the second group of drafts.

Further, the second evaluation unit may be configured to set a relatively high weighted value to the participant who holds a high rank and has a specialty and is a long-term employed person.

Further, the second evaluation unit may be configured to set a relatively high weighted value to criteria considered as the most important element among the drafts compared to the weighted value by the evaluation criteria.

Further, the control unit may be configured to ask a terminal of the participant to participate in the project via a communications network; recognize the participant when the participant participates in the project; and control the participant to execute the project.

Further, the control unit is configured to provide URL address information that the project is being executed to the terminal of the participant.

In accordance with an embodiment of the present invention, there is provided a method, the method including: registering a first group of drafts including at least one or more draft to create a project for evaluating the drafts; setting at least one or more evaluation references to a participant who is to be participated the project and the drafts; executing a first evaluation on the draft included in the first group of drafts based on an evaluation information of a first preference base inputted from the participant when the participant participates in the project; and selecting a final draft that has the most favorable evaluation among the drafts based on the first evaluation result and an evaluation information of a second weighted value base inputted from the participant.

Further, the executing the first evaluation may include displaying a first evaluation screen that includes a name of the project on a terminal of the participant; receiving an evaluation information by the evaluation criteria and a general evaluation information on each of the drafts included in the first group of drafts through the first evaluation screen; and

yielding a draft that has the highest preference by the evaluation reference and the highest general evaluation as a first evaluation result.

Further, the executing the first evaluation may include selecting one draft that has the highest preference by the participant or the group in the manner of a tournaments method on the drafts included in the first group of drafts; and yielding said one draft as the first evaluation result.

Further, the executing the first evaluation may include selecting a draft that has the lowest preference among the first group of drafts before executing the first evaluation; and eliminating the draft from the first group of drafts.

Further, the selecting the final draft may include setting at least one or more drafts selected among the drafts included in the first group of drafts based on the first evaluation result as a second group of drafts; displaying a second evaluation screen that the participant and the weighted value by evaluation criteria are applied; receiving evaluation information by the evaluation reference and general evaluation information on each of the drafts included in the second group of drafts through the second evaluation screen; yielding a second evaluation result on the draft included in the second group of drafts based on the received information and the weighted value; and selecting a final draft that has the most favorable evaluation among the draft included in the second group of drafts based on the second evaluation result.

Further, the yielding the second group of drafts may include yielding one draft that has the most favorable evaluation based on a general evaluation information inputted from each of the participants and on the draft included in the second group of drafts and the weighted value of the participant; and yielding at least one or more drafts that have the highest evaluation by the evaluation criteria based on evaluation information by evaluation criteria inputted from the participant and a weighted value by the evaluation criteria and the weighted value of the participant.

Further, the second group of drafts may include at least one draft selected by the participant among the drafts that is eliminated in the first evaluation or at least one draft selected by an expert group.

In accordance with the invention, in group decision support to select a draft in accord with a request of a client among at least one or more drafts provided from an expert group such as a designer in accordance with a request of product design, advertisement design, service design, and package design etc., there is an advantage that an evaluation having a reliability may be done by selecting a certain number of drafts through a first evaluation based on an evaluation information by participants of a client regarding the drafts provided by the expert group, and by recommending a draft in accord with a request of the client through a second evaluation that a weighted value by participants and a weighted value by the evaluation criteria are again applied regarding the selected draft.

In addition, there is another advantage that is of help to group decision in case of selecting a draft such as a design, etc. without formulaic determination criteria, since it is possible to reliably evaluate the draft.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of a group decision support system in accordance with an embodiment of the invention;

FIG. 2 is a detailed block diagram of a group decision support server in accordance with an embodiment of the invention;

FIG. 3 is an exemplary diagram of a project creation screen in accordance with an embodiment of the invention;

FIG. 4 is an exemplary diagram of an evaluation criteria setting screen in accordance with an embodiment of the invention;

FIG. 5 is an exemplary diagram of a participant selection screen in accordance with an embodiment of the invention;

FIGS. 6 to 11 are exemplary diagrams related to a first evaluation execution in accordance with an embodiment of the invention;

FIG. 12 to FIG. 16 are exemplary diagrams related to a second evaluation execution in accordance with an embodiment of the invention; and

FIG. 17 is a flow chart illustrating a control process for supporting group decision in accordance with an embodiment of the invention.

### DETAILED DESCRIPTION OF THE EMBODIMENTS

Hereinafter, the embodiments of the present invention will be described in detail with reference to the accompanying drawings. In the following description, well-known functions or constitutions will not be described in detail if they would unnecessarily obscure the features of the present invention. Further, the terms to be described below are defined in consideration of functions in the present invention and may vary depending on intentions or practices of a user or an operator. Accordingly, the definition may be made on a basis of the content throughout the specification.

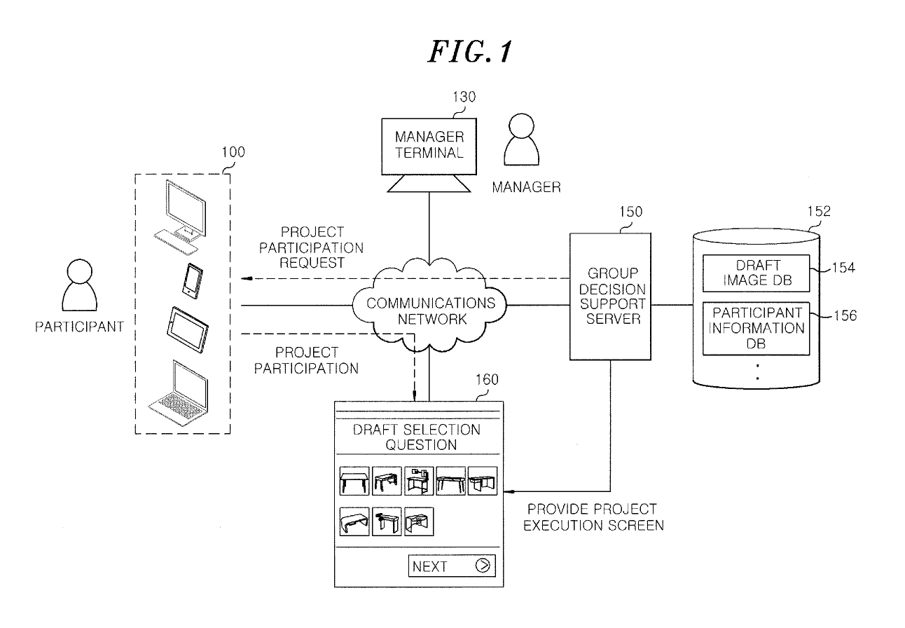

FIG. 1 is a block diagram of a group decision support system in accordance with an embodiment of the invention.

Hereinafter, each of elements in a group decision support system will be described in detail with reference to FIG. 1.

First of all, a participant terminal 100 may be a terminal device that is connected to a system via a communications network such as the Internet, etc., and thus participates in a draft evaluation project executed in a group decision support server 150 and inputs evaluation information of the participant regards to a draft. The terminal device, for example, may be, including but not limited to, a smartphone, a tablet PC, a personal computer (PC), a notebook computer, a desktop PC, etc. that may be connected to the communications network.

In other words, the participant terminal 100 may be referred to as a terminal capable of executing a project as a registered terminal device to the participant who participates in a project executed in the group decision support server 150. For example, in case of being requested to participate in a project from the group decision support server 150, the participant terminal 100 participates in the project by connecting to the group decision support server 150 and receives an evaluation information on a draft registered in the project from the participant and transmits it to the group decision support server 150.

In this example, the participant may be, including but not limited to, a project related employee, etc. of a company that requests a draft for a project. In addition, the participant terminal 100 may be requested to participate in the project by receiving a short message service (SMS) or an e-mail via a mobile phone number and an e-mail address, etc. registered in a group decision support server 150. The messages requesting a participation in the project may include, but not limited to, URL information of a web page that the project is being executed.

A manager terminal 130 may be a terminal device that is connected to the group decision support server 150 via a communications network such as the Internet etc., and selects and inputs a participant in connection with a project execution, or executes a role such as evaluation reference information setting. The manager terminal 130 also may be a terminal device of an expert group who designs a draft that is requested from the client, and the manager who operates the manager terminal 130 may be, including but not limited to, any one of the expert group.

The group decision support server 150 may be a server that creates a project executing an evaluation on a number of drafts registered by an expert group. These drafts, for example, may be a draft on the product, a draft on the advertisement design or a draft on the service design, etc. The server, for example, may be, including but not limited to, a smartphone, a tablet PC, a personal computer (PC), a notebook computer, a desktop PC, etc. that may be connected to the communications network.

In other words, the group decision support server 150 creates a project that executes an evaluation on a number of drafts registered by an expert group, and then after selecting a client, etc. requesting the drafts as a participant and participating them in the project, it is helpful for the client to select at least one of the most appropriate draft among the drafts provided from the expert group by providing an information received the best evaluation based on an evaluation information of the participant who is being participated in the project.

Hereinafter, an operation in the group decision support server 150 will be described in detail.

First of all, the group decision support server 150 may register a first group of drafts on at least one or more drafts designed by an expert group such as a designer, etc. in accordance with a request of a client, and create a project for evaluating a draft included in the first group of drafts. In this case, at least one or more drafts may be stored in an image DB 154) of a storage unit 152 that is managed by the group decision support server 150.

In succession, the group decision support server 150 may select a participant who will execute an evaluation on a draft by participating in a project, and request the participant to participate in the project. In this case, this request may be transmitted as SMS or e-mail, etc. via a registered mobile phone number or e-mail address of the participant, and the messages requesting a participation in the project may include, but not limited to, URL information of a web page that the project is being executed. In addition, the mobile phone number or the e-mail address may be stored in a participant information database (DB) 156 of the storage unit 152 in advance.

Accordingly, the participant who is requested to participate in the project by connecting to the group decision support server 150 via the participant terminal 100 and inputs evaluation information on the first group of drafts registered in the project.

For example, when the participant participates in the project, the group decision support server 150 displays a project execution screen 160 on the participant terminal 100 for executing an evaluation execution on a draft, and yields a first evaluation result on the draft included in the first group of drafts based on the evaluation information by the draft inputted from the participant terminal 100 through the project execution screen 160. Through the first evaluation result, for example, one of the draft that has the highest preference selected by tournaments method, at least one or more drafts that have the most favorable evaluation by evaluation criteria and one of the drafts that have the most favorable evaluation in general evaluation, etc. among the drafts included in the first group of drafts may be selected.

Next, based on the first evaluation results, the group decision support server 150 sets one or more of the drafts selected among the drafts included in the first group of drafts. In this case, all of the draft selected by the first evaluation results tournaments method, the draft received most favorable evaluation by evaluation criteria and the draft received most favorable in general evaluation may be included in the second group of drafts, and among these, only a predetermined number of drafts may be included in the second group of drafts.

Further, the group decision support server 150 again displays a project execution screen 160 on the participant terminal 100 for executing an evaluation execution on a draft and yields a second evaluation result on the draft included in the second group of drafts based on the evaluation information inputted from the participant terminal 100 through the project execution screen 160, and provides a client with the most favorable final draft among the second evaluation results.

In this example, the group decision support server 150 yields a second evaluation result that may be in accord with a request of a client by setting a weighted value by a participant and evaluation criteria and then applying it to an evaluation inputted from the participant terminal 100 in the second evaluation.

Such a weighted value, for example, in case of the weighted value by a participant, may be more highly allocated to an employee who is more related to a draft or hold a high rank, in case of the weighted value by the evaluation criteria, may be more highly allocated to an evaluation item having a close connection with the relevant draft. Accordingly, the group decision support server 150 is helpful for the client to select at least one of the most appropriate drafts among the drafts provided from the expert group by selecting more appropriate draft and recommending it to the client.

Meanwhile, the group decision support server 150 may execute an evaluation on a client who requests the relevant draft for a project as well as a general consumer in case of creating the project that executes the evaluation on at least one or more draft. The consumer may be not the client, but a predetermined number of ordinary people who is randomly selected from the ordinary people. The draft recommended by the consumer based on the evaluation information may be, including but not limited to, provided as reference data during the evaluation process on the draft by the participant.

In addition, the group decision support server 150 applies the same evaluation process targeting the participant to a consumer survey targeting the consumer, for example, yields the most favorable draft by the evaluation criteria, and then enables the yielded draft to be provided the relevant participant as reference data by the participant when the project is executed.

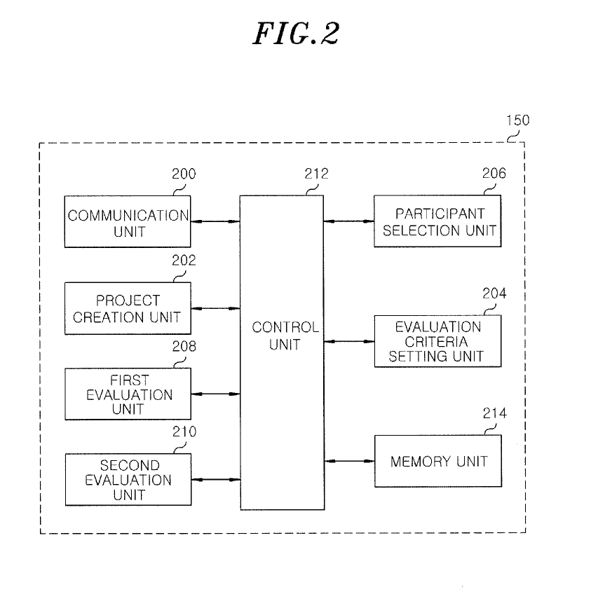

FIG. 2 is a detailed block diagram of the group decision support server 150 in accordance with an embodiment of the invention. As shown in drawing, the group decision support server 150 may be comprised of a communication unit 200, a project creation unit 202, an evaluation criteria setting unit 204, a participant selection unit 206, a first evaluation unit 208, a second evaluation unit 210, a control unit 212, and a memory unit 214.

Hereinafter, an operation of each of elements of the group decision support server 150 will be described in detail with reference to FIG. 2.

First of all, the communication unit 200 may be connected to the participant terminal 100 or the manager terminal 130 via a communications network, and interfaces a data that is transmitted or received between the participant terminal 100 or the manager terminal 130 and the server 150 along with a project execution.

In other words, the communication unit 200, for example, may transmit a project participation request to the participant terminal 100 of the relevant participant who is selected to participate in a project along with the project execution, and receive evaluation information on a draft included in the project inputted from the participant terminal 100.

The project creation unit 202 registers a first group of drafts including at least one or more draft, and creates a project for evaluating the drafts. At this time, the draft may be at least one or more drafts designed by an expert group such as a designer, etc. in accordance with a request of a client regarding a product design draft, an advertisement design draft or a service design draft, etc. The project creation unit 202 may register a first group of drafts regarding at least one or more draft, and create a project for evaluating a draft included in the first group of drafts.

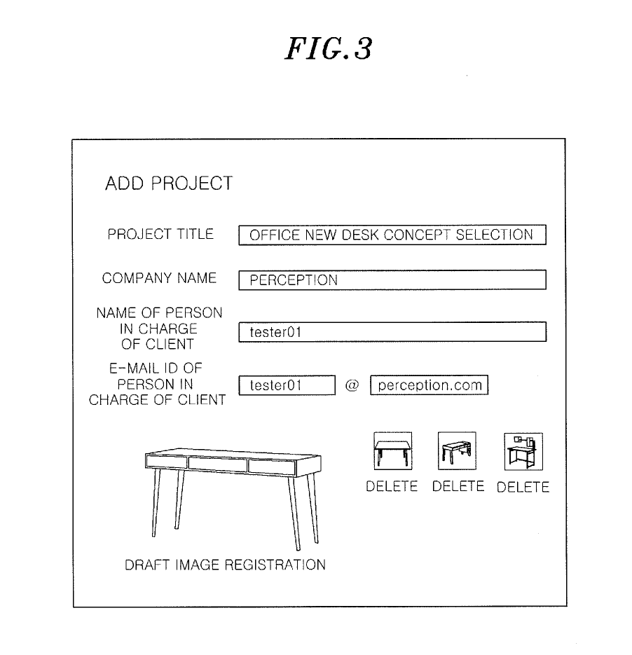

FIG. 3 is an exemplary project creation screen created by the project creation unit 202 among the project execution screens in accordance with an embodiment of the invention, in which an information such as a project title and a registered draft image, etc. may be included in the project creation screen. In addition, in the above FIG. 3, “office new desk concept selection” etc. is illustrated as a created project title, and thus, a registered draft image is, including but not limited to, illustrated as a number of desk design drafts.

In other words, for example, when a client requests a new desk design to be used in the company, as shown in FIG. 3, an expert group such as a designer, etc. provides a number of designed desk drafts, and the project creation unit 202 registers the number of designed desk drafts as a first group of drafts of a project, and then executes the project for evaluating the registered desk drafts. In addition, as shown in FIG. 3, information such as a project title and a name of company requesting the project, a name and an e-mail address of the client's person in charge of the project, a permission or non-permission of consumer survey may be included in the project creation screen.

The evaluation criteria setting unit 204 may set at least one or more evaluation criteria on a draft included in the first group of drafts registered when the project is created in the project creation unit 202.

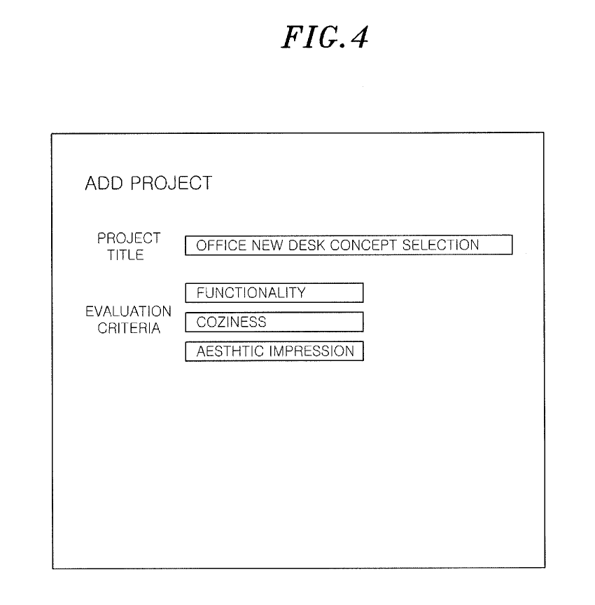

FIG. 4 is an exemplary diagram of an evaluation criteria setting screen in accordance with an embodiment of the invention. As shown in FIG. 4, evaluation criteria, for example, may be set as “functionality, coziness, and aesthetic impression” etc., and a brief description regarding each of the evaluation criteria may be included in each of the evaluation criteria for enabling a participant to correctly understand the evaluation criteria. In this case, the evaluation criteria, for example, may be inputted by a manager of the server 150 and set, including but not limited to, as evaluation criteria for evaluating a draft.

The participant selection unit 206 selects a participant who is to be participated in a project when the project is created in the project creation unit 202. In this connection, in selecting the participant, when the client is a person, the participant selection unit 206, for example, may select a relevant person who requests a draft, and when the client is a company, the participant selection unit 206 may, including but not limited to, select a related employee of the relevant company as a participant.

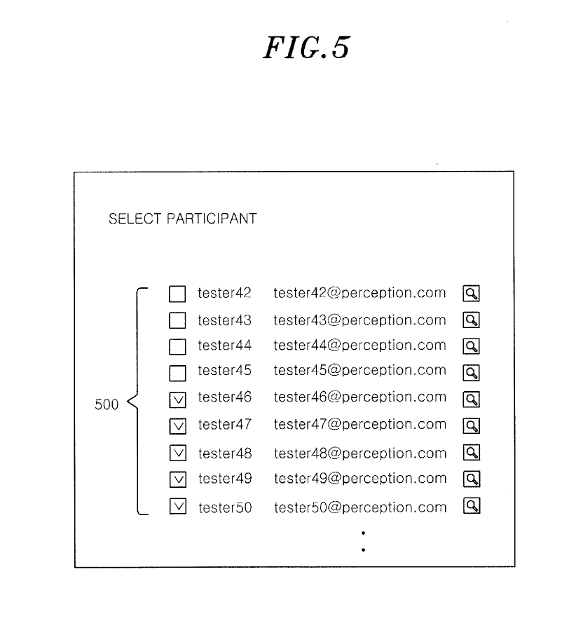

FIG. 5 is an exemplary diagram of a participant selection screen in accordance with an embodiment of the invention. As illustrated in FIG. 5, a manager may select a participant who is to be participated in a project from the screen displaying a list of a number of participants. In that case, the participant selection unit 206 recognizes the selected participant among the participant list on the screen and selects the selected participant as a participant who is to be participated in the relevant project. In this regard, in accordance with an embodiment of the invention, even though the participant selected by the manager is illustrated as the participant who is to be participated in the project in a state of displaying the participant list (500 on the screen, it only describes the embodiment for the convenience, and various different method may be used to select the participant.

As described above, when the evaluation criteria and the participant is selected by the evaluation setting unit 204 and the participant selection unit 206, the first evaluation unit 208 yields a first evaluation result based on the inputted evaluation information. In addition, based on the first evaluation result, the first evaluation unit 208, for example, may select one draft finally selected by a tournaments method among the drafts included in the first group of drafts, at least one or more drafts that have the most favorable evaluation by evaluation criteria, and one draft that has the most favorable in a general evaluation, etc.

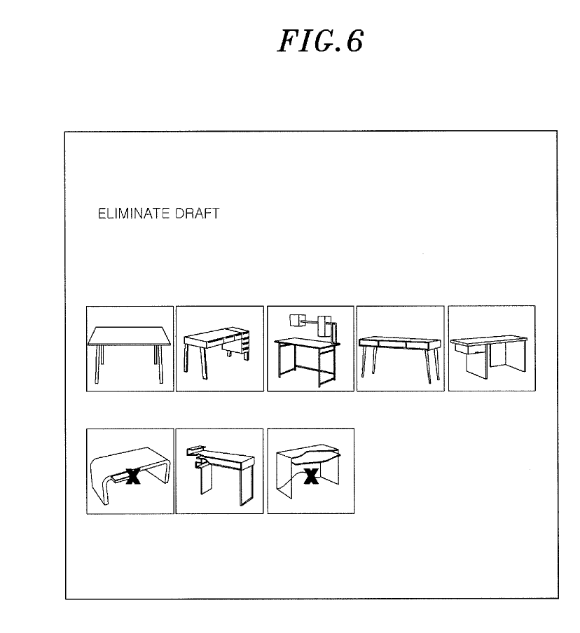

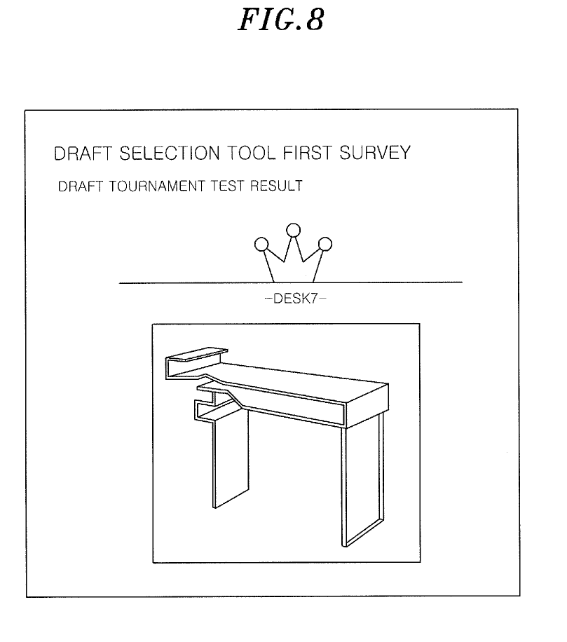

FIGS. 6 to 11 illustrate an exemplary screen related to a first evaluation execution among the project execution screens in accordance with an embodiment of the invention.

Hereinafter, an operation that executes a first evaluation on the drafts included in a first group of drafts in the first evaluation unit 208 will be described in detail with reference to FIG. 6 to FIG. 11.

First of all, when a participant participate in a project, the first evaluation unit 208 selects a draft that has the lowest evaluation through a draft exception screen shown in FIG. 6, before receiving an evaluation information on the drafts included in a first group of drafts. For example, the draft exception screen shown in FIG. 6 may be displayed on the participant terminal 100 such that selected information may be inputted through a key input, etc. on the screen displayed on the participant terminal 100. Accordingly, as illustrated in FIG. 6, the participant, for example, may select two removal object drafts, and in this case, the first evaluation unit 208 may execute a work removing the relevant drafts from the first group of drafts.

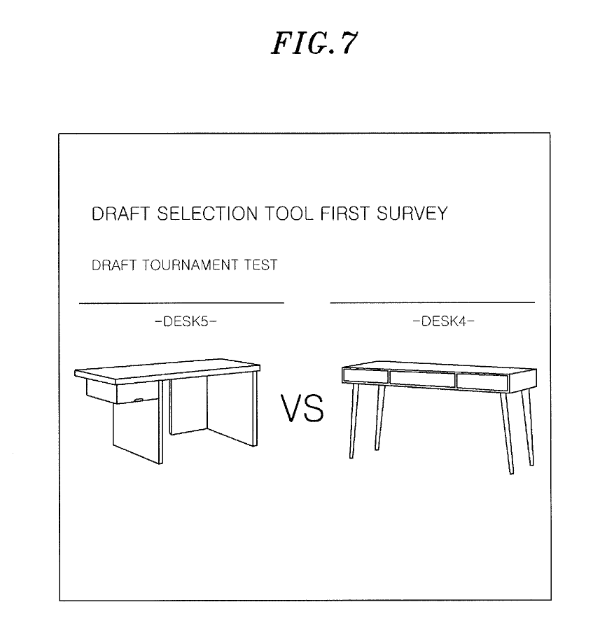

Subsequently, as described above, when an exception process on a specific draft is completed, the first evaluation unit 208 provides a tournaments evaluation screen shown in FIG. 7 to the participant terminal 100 such that the participant may select the most favorable draft in the manner of tournaments on the drafts included in a first group of drafts. Accordingly, the participant selects the most favorable draft among two drafts suggested in the manner of tournaments at the tournaments evaluation screen shown in FIG. 7, and the selection of the participant may be transmitted to the first evaluation unit 208 through the participant terminal 100.

The first evaluation unit 208 executes a process for selecting a draft on all of the rest drafts in the manner of tournaments, and may choose the draft finally selected by the participant as the most favorable draft of the tournaments method.

Next, as described above, when a draft selection process of the tournaments method is completed, the first evaluation unit 208 may choose at least one or more drafts that have the most favorable evaluation by evaluation criteria by again receiving an evaluation information by the evaluation criteria from the participant regards to the draft included in the first group of drafts.

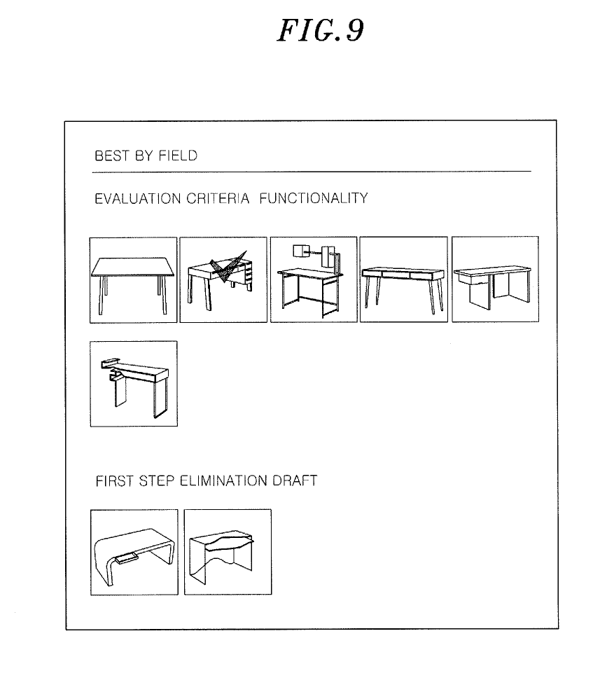

FIG. 9 is an exemplary diagram of an evaluation information input screen by evaluation criteria among the project execution screens in accordance with an embodiment of the invention.

In other words, as shown in FGI. 9, the first evaluation unit 208 provides an evaluation information input screen by evaluation criteria, therefore, the participant, for example, may select the most favorable draft among the drafts included in the first group of drafts from “functionality” item of the evaluation criteria. Accordingly, as shown in FIG. 9, the participant, for example, may select a draft in accord with “functionality” from the evaluation information input screen by the evaluation criteria, and the selection of the participant may be transmitted to the first evaluation unit 208 via the participant terminal 100.

In accordance with the above method, the first evaluation unit 208 may select a draft by evaluation criteria in accord with the drafts included in the first group of drafts and choose one draft that has the most favorable evaluation by the evaluation criteria. In an embodiment of the invention, for example, because items of the evaluation criteria are set as “functionality, coziness, and aesthetic impression” etc., one at a time by the evaluation criteria, that is, total three drafts may be chosen.

Further, as described above, when a draft selection process by evaluation criteria is completed, the first evaluation unit 208 may again receive a general evaluation information on the drafts included in the first group of drafts from the participant and choose one draft that has the most favorable general evaluation.

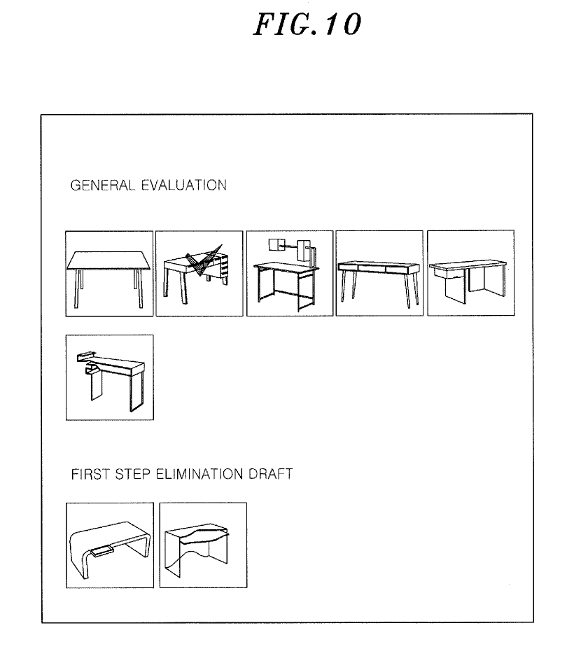

FIG. 10 is an exemplary diagram of a general evaluation input screen among the project execution screens in accordance with an embodiment of the invention.

In other words, as shown in FIG. 10, the first evaluation unit 208 provides a general evaluation information input screen such that the participant, for example, may select the most favorable draft among the drafts included in the first group of drafts not from the detailed point of view by evaluation criteria, but from the general point of view. Accordingly, as shown in FIG. 10, the participant may select one draft regarded as the draft in accord with a project from the general point of view, and the selection of the participant may be transmitted to the first evaluation unit 208 via the participant terminal 100.

In the manner of the above, the first evaluation unit 208 may select a draft in accord with the drafts included in the first group of drafts from the general point of view and choose one draft that has the most favorable evaluation in a general evaluation.

Specifically, as described above, the first evaluation unit 208 may yield one draft finally selected in tournaments method, for example, based on an evaluation information from the participant on the drafts included in the first group of drafts, at least one or more drafts that have the most favorable evaluation by evaluation criteria and one draft that has the most favorable evaluation in a general evaluation, etc. as a first evaluation result. In this case, for example, the first evaluation unit 208 may yield and provide the evaluation result by the person with respect to the first evaluation result, and yield and provide a group evaluation result that an opinion of all participants is integrated.

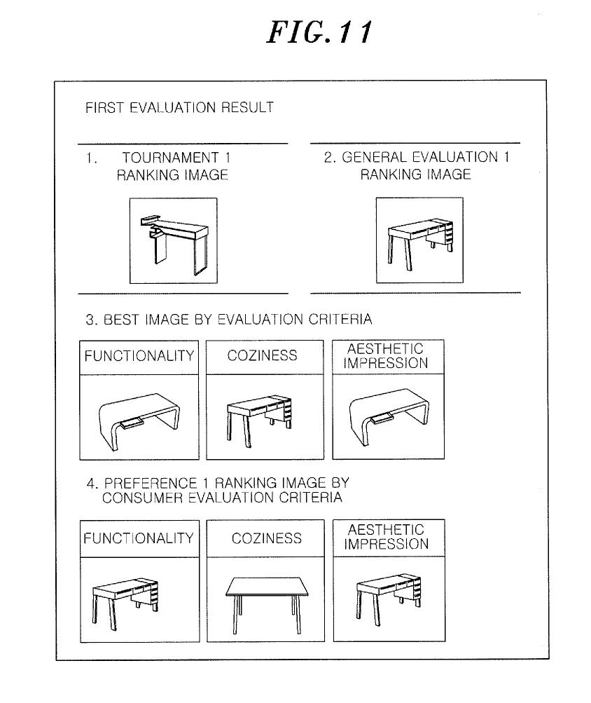

FIG. 11 is an exemplary diagram of a first evaluation result screen among the project execution screens in accordance with an embodiment of the invention. In the FIG. 11, a draft selected through a tournaments method, a draft selected in a general evaluation, a draft selected by evaluation criteria, a draft selected by evaluation criteria through a consumer survey, etc., including but not limited to, is illustrated as a first evaluation results.

In this regard, even though an operation of a draft selection process by evaluation criteria through a consumer survey is not described in detail in the first evaluation unit 208, if necessary, before executing a first evaluation targeting the participant, the first evaluation unit 208 may survey and choose the most favorable draft by the evaluation criteria in the same manner as the first evaluation by participating a number of unspecified consumer who is directly not related to a project as a participant. Therefore, as shown in FIG. 11, the most favorable draft by the evaluation criteria selected by the unspecified consumer may be provided as reference data.

Next, as the above, when a first evaluation is completed through the first evaluation unit 208, the second evaluation unit 210 sets at least one or more drafts selected among the drafts included in the first group of drafts as the second group of drafts. For example, all of a draft selected by a tournaments method based on the first evaluation result, the most favorable draft by evaluation criteria, and a draft that has the most favorable evaluation in a general evaluation may be included in the second group of drafts, and among these, only a predetermined number of drafts may be included in the second group of drafts.

The second evaluation unit 210 then receives evaluation information on the drafts included in the second group of drafts from the participant and yields a second evaluation result on the drafts included in the second group of drafts based on the received evaluation information. Further, the second evaluation unit chooses the final draft that has the most favorable evaluation and provides it to a client.

In other words, the second evaluation unit 210 may choose one draft that has the most favorable evaluation based on a general evaluation information inputted by each of the participants on the drafts included in the second group of drafts and a weighted value allocated to each of the participant, and choose one draft by evaluation criteria that has the most favorable evaluation based on evaluation information by evaluation criteria inputted by each of the participants, a weighted value by the evaluation criteria and a weighted value allocated to each of the participants, thereby yielding it as the second evaluation result.

In this case, the weighted value, for example, may be more highly allocated to an employee who is closely related to the relevant draft or hold a high rank, etc. In addition, in case of the weighted value by the evaluation criteria, it may be more highly allocated to an evaluation item that is closely related to the relevant draft. Accordingly, the group decision support server 150 may select more favorable draft and be recommended to a client, and therefore, it is helpful for the client to select the most favorable draft among a number of drafts provided by an expert group.

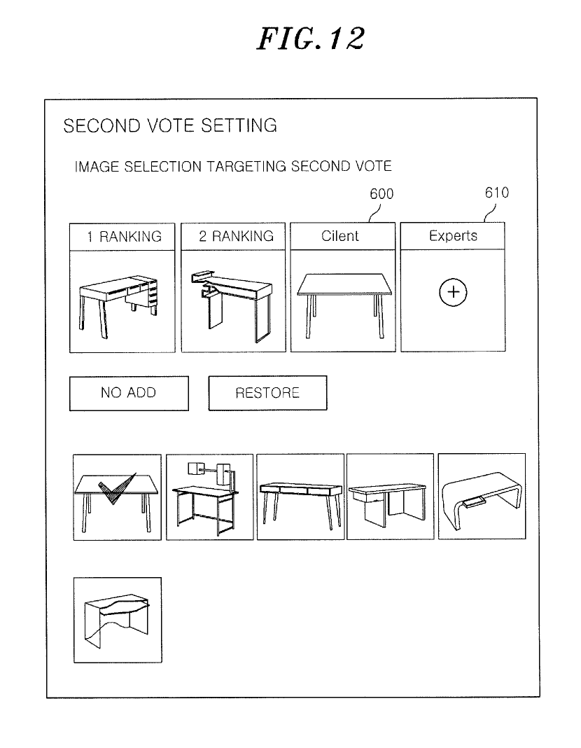

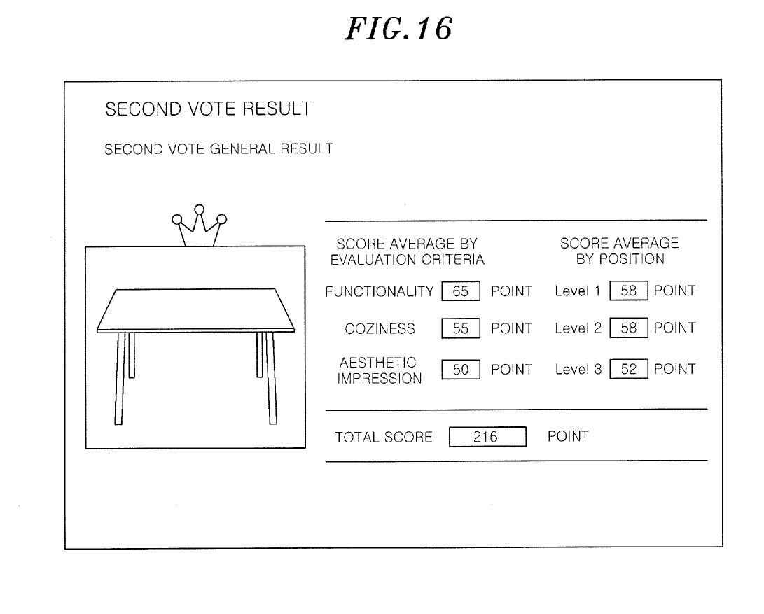

FIGS. 12 to 16 are exemplary diagrams related to a second evaluation execution in accordance with an embodiment of the invention.

Hereinafter, an operation of the second evaluation unit 210 executing a second evaluation on the drafts registered in the second group of drafts will be described in detail with reference to FIG. 12 to FIG. 16.

First of all, as shown in FIG. 12, before the second evaluation, the second evaluation unit 210 may have the participant 100 select one draft among the drafts included in the second group of drafts as well as the drafts that be eliminated from the first evaluation through a draft addition screen. At this time, as shown in FIG. 12, the draft addition screen may be displayed on the participant terminal 100, therefore, the participant may input the selected information through a key input, etc. in the screen displayed on the participant terminal 100.

Accordingly, as shown in FIG. 12, the participant, for example, may select one draft among two drafts included in the second group of drafts and finally selected according to the first evaluation result as well as the drafts that be eliminated, and like this, when the selection is done by the participant, the second evaluation unit 210 executes a second evaluation by including a draft 600 selected as an addition draft in the second group of drafts.

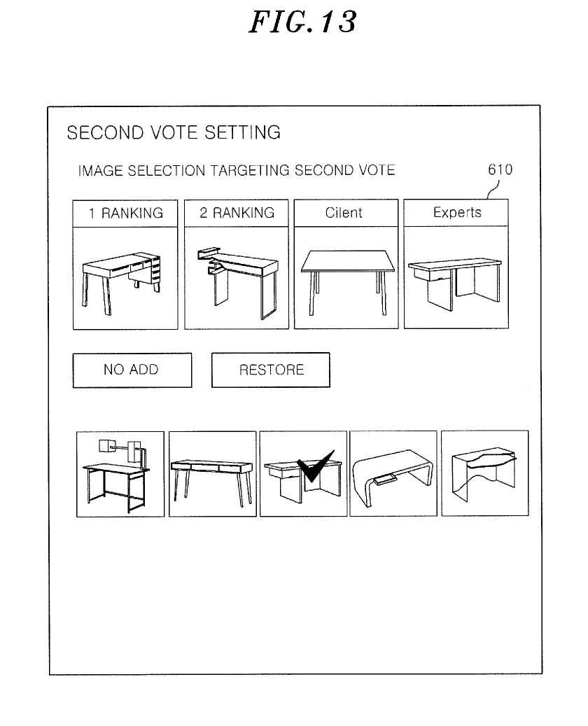

In this example, in relation to the draft addition, as shown in reference number 610 of FIG. 12, it is possible to add a draft after further selecting it from the selection of the participant as well as an expert group who designed the drafts. In an operation of the draft addition, as similar as the process selected from the participant, it is possible to perform the draft addition in a way that the draft addition screen shown in FIG. 13 is provided to the manager terminal 130 before executing the second evaluation; and one draft is then selected by the expert group among the drafts included in the second group of drafts as well as the drafts that have been eliminated in the first evaluation and is added to the second group of drafts by recognizing the draft 610 selected in the manager terminal 130. In this regard, in an embodiment of the invention, the manager who manages the group decision support server 150 may be an expert group of a design company, therefore, even though the relevant manager is considered as an expert group and one addition draft is selected in the manager terminal 130 and as an example may be included in the second group of drafts, when there is a separate expert group, it is possible to transmit a request of draft addition to the relevant expert group.

In addition, when a process of the second group of drafts that a part of drafts 600, 610 among the eliminated drafts is to be included in the second group of drafts is completed, the second evaluation unit 210 may provide a weighted value setting screen shown in FGI. 14 to the participant terminal 100 and allow the participant to set a weighted value by evaluation criteria and a weighted value by the participant on the drafts included in the second group of drafts.

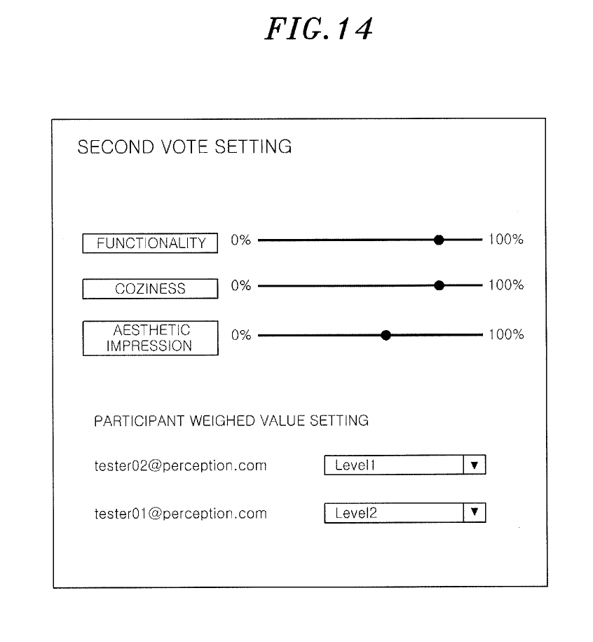

Accordingly, as shown in FIG. 14, the participant may set a weighted value by the participant in a weighted value setting screen and a weighted value by evaluation criteria. The weighted value set by the participant may be transmitted to the second evaluation unit 210 through the participant terminal 100. In this case, the weighted value, for example, may be more highly allocated to an employee who is closely related to the relevant draft or hold a high rank, etc. In addition, in case of the weighted value by the evaluation criteria, it may be more highly allocated to an evaluation item that is closely related to the relevant draft. In other words, for example, in case of the weighted value by the participant, it may be more highly and sequentially set to an assistant manager, a manger, a senior manager, a general manager, etc. than the staff of the department. In addition, in case of setting the weighted value, it may not be set by all of the participants who executing an evaluation on the draft included in the second group of drafts, but, for example, be set by the participant who is a core employee of the related department of a client and in charge of the project.

As described above, when a weighted value setting is completed, the second evaluation unit 210 again receives an evaluation information by evaluation criteria and a general evaluation information from the participant on the draft included in the second group of drafts, and then may select one draft that has the most favorable evaluation as a final draft.

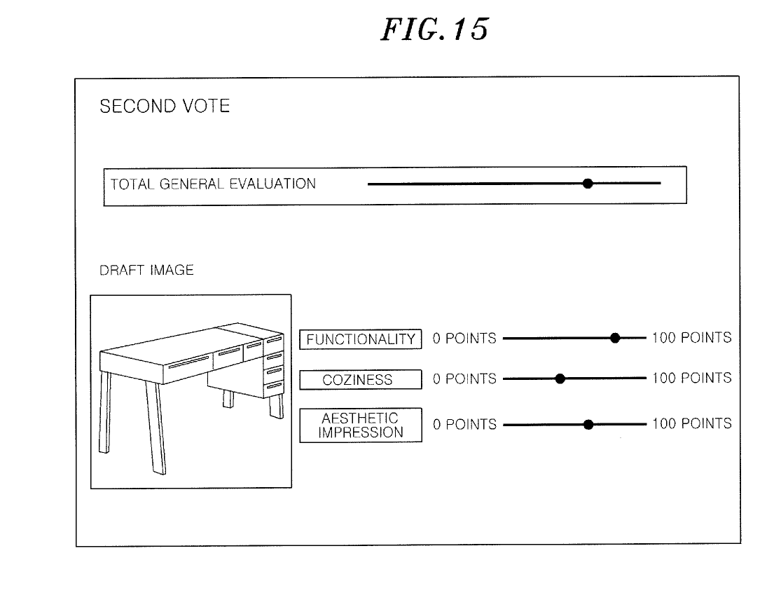

FIG. 15 is an exemplary diagram of general evaluation information and an evaluation information input screen among the project execution screens in accordance with an embodiment of the invention.

In other words, the second evaluation unit 210 provides an evaluation information input screen shown in FIG. 15 such that the participant may input a score by evaluation criteria according to segmented evaluation criteria by items such as “functionality, coziness, and aesthetic impression” etc. on each of the drafts included in the second group of drafts and input total general evaluation score, and then it may be transmitted to the second evaluation unit 210 through the participant terminal 100.

In the manner as described above, after the second evaluation unit 210 receives a score by evaluation criteria and a general evaluation score from each of the participant on the drafts included in the second group of drafts, it may apply a weighted value by the participant and a weighted value by evaluation criteria to a score that each of the drafts obtains and yield a second evaluation result. The second evaluation unit may then provide a draft that has the most favorable evaluation according to the second evaluation as a final draft.

Like this, a finally selected draft is a draft selected by a number of the person as the most favorable draft by applying a weighted value by the participant and a weighted value by evaluation criteria, therefore, it is helpful for a client to select at least one draft that has the most favorable evaluation among a number of drafts provided by an expert group.

The control unit 212 controls overall operation of the group decision support server 150 according to an operating program stored in the memory unit 214.

In addition, in case of creating a project in accordance with an embodiment of the invention, it asks the participant to participate in a project, and recognizes the relevant participant and has the participant execute the project when the participant participates in the project, and then may provide a final draft yielded through the first evaluation unit 208 and the second evaluation unit 210 as a final result information to a client.

In this case, the control unit 212 may provide URL information that a project is being executed to the participant terminal 100 via a communications network and then ask to participate in the project. Further, the control unit may control e-mail address or a mobile phone number of the participant to transmit a request of the participation.

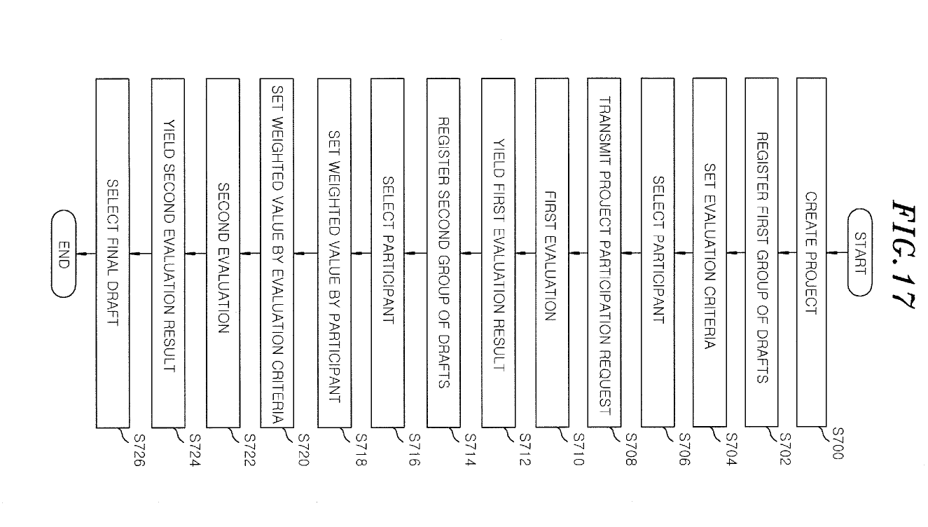

FIG. 17 is a flow chart illustrating a control process for supporting group decision on the drafts of a product or an advertisement, and a service draft in the group decision support server in accordance with an embodiment of the invention. Hereinafter, an embodiment of the invention will be described in detail with reference to FIG. 1 to FIG. 17.

First of all, the group decision support server 150 creates a project for evaluating a draft 700, and registers a first group of drafts on at least one or more drafts designed by an expert group such as a designer, etc. according to a request, etc. from a client, at block S702. The draft, for example, may be, including but not limited to, a product design draft, an advertisement design draft, and a service design draft, etc.

Next, the group decision support server 150 may set at least one or more evaluation criteria on the draft included in a first group of drafts, in block S704. As shown in FIG. 4, the evaluation criteria, for example, may be set, including but not limited to, as a “functionality, coziness, and aesthetic impression” etc. Also, it is helpful for a client to correctly understand the evaluation criteria, since a brief description on each of the evaluation criteria is included in the evaluation criteria.

In addition, in case of setting the evaluation criteria as the above, the group decision support server 150 may choose a participant who is to be participated in a project and evaluate the draft, in block S706, and may ask the relevant participant to participate in the project, in block S708. In this case, the request of the participation may be transmitted to the participant as SMS or an e-mail, etc. via a registered mobile phone number or an e-mail address, and the project participation request message may, including but not limited to, include URL information of a web page that the project is being executed.

Accordingly, the participant who receives the participation request connects the group decision support server 150 through the participant terminal 100 and participates in a project and then input evaluation information on the draft of the first group of drafts registered in the project.

In this case, as described above, when the participant participates in a project, the group decision support server 150 displays a first evaluation screen like in FIG. 6 to FIG. 10 for evaluating an evaluation execution on the participant terminal 100. After that, the group decision support server executes a first evaluation based on the evaluation information inputted from the participant terminal 100 through the first evaluation screen, in block S710, and then yields a first evaluation result on the drafts included in the first group of drafts, in block S712.

In case of yielding the first evaluation result, the group decision support server 150 may yield one finally selected draft based on an evaluation information from the participant on the drafts included in the first group of drafts, at least one or more drafts that have the most favorable evaluation by evaluation criteria and one draft that has the most favorable evaluation in a general evaluation as a first evaluation result. In addition, in case of yielding the first evaluation result, the group decision support server 150 may yield an evaluation result by the person on the first evaluation result and provide it, and may also yield a group evaluation result that integrates an opinion of all participants and provide it.

Subsequently, in case of yielding the first evaluation result, the group decision support server 150 registers at least one or more drafts selected among the drafts included in the first group of drafts based on the first evaluation result as a second group of drafts, in block S714. At this time, a draft that has the most favorable evaluation by evaluation criteria according to the first evaluation result and a draft that has the most favorable evaluation in a general evaluation may be included in the second group of drafts. In addition, among these drafts, a first rank draft and a second rank draft by total evaluation ranking may be included in the second group of drafts, and also a draft selected by a client among the drafts that eliminated in the first evaluation and a draft selected by an expert group may be further included in the second group of drafts.

In succession, as the above, when the registration on the second group of drafts is completed, the group decision support server 150 chooses a participant who is to be executed an evaluation on a draft included in the second group of drafts, in block S716. In this example, the participant who is to be participated in the first evaluation may be chosen as the same participant, otherwise, may be, including but not limited to, changed as a totally different participants.

After that, the group decision support server 150 sets a weighted value by the participant to the participant who participates in the second evaluation, in block S718; and sets a weighted value by evaluation criteria, in block S720. In case of setting the weighted value, the group decision support server 150 may set the weighted value based on a setting information of the weighted value received from a specific participant who has authority to the weighted value setting among the participants, the specific participant, for example, may be, including but not limited to, a participant who is a core employee of the related department of a client and in charge of the project. In addition, the weighted value, for example, in case of the weighted value by a participant, may be more highly allocated to an employee who is more related to a draft or hold a high rank, in case of the weighted value by the evaluation criteria, may be more highly allocated to an evaluation item having a close connection with the relevant draft.

As mentioned above, when the weighted value setting is completed, the group decision support server 150 again displays a second evaluation screen shown in FIG. 15 on the participant terminal 100 for a second evaluation and executes the second evaluation based on an evaluation information inputted from the participant terminal 100 through the second evaluation screen, in block S722. Finally, the group decision support server yields a second evaluation result on the drafts included in the second group of drafts, in block S724.

Next, the group decision support server 150 selects the most favorable final draft among the drafts included in the second group of drafts based on the second evaluation result and provides it to a client, in block S726.

Accordingly, it is possible to select a draft in accord with a request of a client based on the first and second evaluation results and, therefore, it is helpful for the client who requests a draft to select at least one draft that has the most favorable evaluation among a number of drafts provided by an expert group.

As described above, in accordance with the invention, in group decision support to select a draft in accord with a request of a client among at least one or more drafts provided from an expert group such as a designer in accordance with a request of product design, advertisement design, service design, and package design etc., it is of help to group decision when the draft is selected without formulaic determination criteria such as a design by selecting a certain number of drafts through a first evaluation based on an evaluation information by participants of a client regarding the drafts provided by the expert group, and by recommending a draft in accord with a request of the client through a second evaluation that a weighted value by participants and a weighted value by the evaluation criteria are again applied regarding the selected draft.

While the present invention has been shown and described with respect to the embodiments, the present invention is not limited thereto. It will be understood by those skilled in the art that various changes and modifications may be made without departing from the scope of the invention as defined in the following claims.

What is claimed is:

1. A group decision support server, comprising:
a project creation unit configured to register a first group of drafts including at least one or more draft and create a project for evaluating the drafts;
a participant selection unit configured to select a participant who is to be participated in the project;
an evaluation criteria setting unit configured to set at least one or more evaluation criteria on the draft;
a first evaluation configured to yield a first evaluation result based on evaluation information of a first preference base inputted from the participant when the participant participates in the project;
a second evaluation unit configured to select a final draft that has the most favorable evaluation based on the first evaluation result and an evaluation information of a second weighted value base inputted from the participant; and
a control unit configured to execute the project and provide a final draft yielded in the second evaluation unit as final result information of the project.

2. The group decision support server of claim 1, wherein the first evaluation unit is configured to provide a first evaluation screen including a name of the project when a user terminal of the participant is connected via a communications network; receive an evaluation information by the evaluation criteria and a general evaluation information on each of the drafts included in the first group of drafts; and yield a draft that has the highest preference by the evaluation criteria and the highest general evaluation as the first evaluation result.

3. The group decision support server of claim 2, wherein the first evaluation unit is configured to select one draft that has the highest preference by an individual or a group of the participants in the manner of tournaments method on the drafts included in the first group of drafts; and yield the draft as the first evaluation result.

4. The group decision support server of claim 1, wherein the second evaluation unit is configured to set at least one or more drafts selected among the drafts included in the first group of drafts as the second group of drafts based on the first evaluation result; display a second evaluation screen that the participant and the weighted value by the evaluation criteria are applied; receive an evaluation information by the evaluation criteria and the general evaluation information on each of the drafts included in the second group of drafts; yield a second evaluation result based on the inputted information and the weighted value; and select a final draft that has the most favorable evaluation among the drafts included in the second group of drafts based on the second evaluation result.

5. The group decision support server of claim 4, wherein the second evaluation unit is configured to yield one draft that has the favorable evaluation based on the general evaluation information inputted from each of the participants and a weighted value of each of the participant; yield at least one or more drafts that have the favorable evaluation by the evaluation criteria based on the evaluation information by the evaluation criteria inputted from the participant and the weighted value by the evaluation criteria and the weighted value of the participant; and yield them as the second evaluation result.

6. The group decision support server of claim 1, wherein the first evaluation unit is configured to receive a draft that has the lowest preference among the first group of drafts; and eliminate the draft from the first group of drafts.

7. The group decision support server of claim 4, wherein the second evaluation unit is configured to add at least one draft selected by the participant among the eliminated drafts in the first evaluation or at least one draft selected by an expert group to the second group of drafts.

8. The group decision support server of claim 4, wherein the second evaluation unit is configured to set a relatively high weighted value to the participant who holds a high rank and has a specialty and is a long-term employed person.

9. The group decision support server of claim 4, wherein the second evaluation unit is configured to set a relatively high weighted value to criteria considered as the most important element among the drafts compared to the weighted value by the evaluation criteria.

10. The group decision support server of claim 1, wherein the control unit is configured to ask a terminal of the participant to participate in the project via a communications network; recognize the participant when the participant participates in the project; and control the participant to execute the project.

11. The group decision support server of claim 10, wherein the control unit is configured to provide URL address information that the project is being executed to the terminal of the participant.

12. A group decision support method, comprising:
registering a first group of drafts including at least one or more draft to create a project for evaluating the drafts;
setting at least one or more evaluation references to a participant who is to be participated the project and the drafts;
executing a first evaluation on the draft included in the first group of drafts based on an evaluation information of a first preference base inputted from the participant when the participant participates in the project; and
selecting a final draft that has the most favorable evaluation among the drafts based on the first evaluation result and an evaluation information of a second weighted value base inputted from the participant.

13. The group decision support method of claim 12, wherein said executing the first evaluation comprises:
displaying a first evaluation screen that includes a name of the project on a terminal of the participant;
receiving an evaluation information by the evaluation criteria and a general evaluation information on each of the drafts included in the first group of drafts through the first evaluation screen; and
yielding a draft that has the highest preference by the evaluation reference and the highest general evaluation as a first evaluation result.

14. The group decision support method of claim 13, wherein said executing the first evaluation further comprises:
selecting one draft that has the highest preference by the participant or the group in the manner of a tournaments method on the drafts included in the first group of drafts; and
yielding said one draft as the first evaluation result.

15. The group decision support method of claim 13, wherein said executing the first evaluation further comprises:
selecting a draft that has the lowest preference among the first group of drafts before executing the first evaluation; and
eliminating the draft from the first group of drafts.

16. The group decision support method of claim 12, wherein said selecting the final draft comprises:
setting at least one or more drafts selected among the drafts included in the first group of drafts based on the first evaluation result as a second group of drafts;
displaying a second evaluation screen that the participant and the weighted value by evaluation criteria are applied;
receiving evaluation information by the evaluation reference and general evaluation information on each of the drafts included in the second group of drafts through the second evaluation screen;
yielding a second evaluation result on the draft included in the second group of drafts based on the received information and the weighted value; and
selecting a final draft that has the most favorable evaluation among the draft included in the second group of drafts based on the second evaluation result.

17. The group decision support method of claim 16, wherein said yielding the second group of drafts comprises:
yielding one draft that has the most favorable evaluation based on a general evaluation information inputted from each of the participants and on the draft included in the second group of drafts and the weighted value of the participant; and
yielding at least one or more drafts that have the highest evaluation by the evaluation criteria based on evaluation information by evaluation criteria inputted from the participant and a weighted value by the evaluation criteria and the weighted value of the participant.

18. The group decision support method of claim 16, wherein the second group of drafts includes at least one draft selected by the participant among the drafts that is eliminated in the first evaluation or at least one draft selected by an expert group.
